(19) United States
(12) Patent Application Publication
(10) Pub. No.: US 2026/0101082 A1
(43) Pub. Date: Apr. 9, 2026

(54) IMAGE PROCESSING METHOD, IMAGE MIRRORING METHOD AND IMAGE PROCESSING DEVICE

(71) Applicant: MEDIATEK INC., Hsinchu City (TW)

(72) Inventor: Sheng-Hsiung Yu, Hsinchu City (TW)

(73) Assignee: MEDIATEK INC., Hsinchu City (TW)

(21) Appl. No.: 19/333,335

(22) Filed: Sep. 18, 2025

Related U.S. Application Data
(60) Provisional application No. 63/703,247, filed on Oct. 4, 2024.

(51) Int. Cl. H04N 21/43; H04N 21/239

(52) U.S. Cl. CPC H04N 21/43079; H04N 21/2393

(57) ABSTRACT

An image processing method, applied to a first electronic device, comprising: the first electronic device acquiring a first target image from an image source which is a software image generation module in the first electronic device; a display of the first electronic device receiving the first target image and transmitting the first target image to an encoder; and the display transmitting a request to inform the encoder to encode the first target image.

### CROSS REFERENCE TO RELATED APPLICATIONS

This application claims the benefit of U.S. Provisional Application No. 63/703,247, filed on Oct. 4, 2024. The content of the application is incorporated herein by reference.

### BACKGROUND

The present application relates to an image processing method, an image mirroring method and an image processing device, and particularly relates to an image processing method an image mirroring method and an image processing device which can reduce image processing latency or image mirroring latency.

With the advancement of electronic technology, image mirroring (also known as screen mirroring) is becoming increasingly popular. However, in related technologies, the procedure of generating an image on one electronic device (such as a mobile phone) and mirroring it to another electronic device (such as a TV) typically has a long data path. This can cause latency in the image displaying on the two different electronic devices during image mirroring.

Therefore, a new image mirroring method is needed to improve this problem.

### SUMMARY

One objective of the present application is to provide an image processing method which can reduce the image processing latency.

Another objective of the present application is to provide an image mirroring method which can reduce the image displaying latency.

Still another objective of the present application is to provide an image processing device which can reduce the image processing latency.

One embodiment of the present application discloses an image processing method, applied to a first electronic device, comprising: the first electronic device acquiring a first target image from an image source which is a software image generation module in the first electronic device; a display of the first electronic device receiving the first target image and transmitting the first target image to an encoder; and the display transmitting a request to inform the encoder to encode the first target image.

Another embodiment of the present application discloses an image mirroring method, applied to a first electronic device and a second electronic device, comprising: the first electronic device acquiring a first target image from a software image generation module in the first electronic device; a display of the first electronic device receiving the first target image and transmitting the first target image to an encoder in the first electronic device; the display transmitting a request to inform the encoder to encode the first target image; the encoder encoding the first target image to generate a target video stream; and transmitting the target video stream to a second electronic device via communication paths, for image mirroring.

Still another embodiment of the present application discloses an image processing device, comprising: a display; an image source; an encoder; and a processing circuit, configured to execute at least one program to perform an image processing method. The image processing method comprises: the image processing device acquiring a first target image from the image source which is a software image generation module in the image processing device; a display of the image processing device receiving the first target image and transmitting the first target image to an encoder; and the display transmitting a request to inform the encoder to encode the first target image.

In view of above-mentioned embodiments, the displaying latency of the image mirroring method and the processing latency of the image processing method can be reduced, since the data paths are shorten.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an image mirroring method according to one embodiment of the present application.

FIG. 2 is a schematic diagram illustrating an image mirroring method according to another embodiment of the present application.

FIG. 3 is a detail schematic diagram of the image mirroring method in FIG. 1, according to one embodiment of the present application.

FIG. 4 is a block diagram illustrating a first electronic device which can perform the image mirroring method illustrated in the embodiments of the present application, according to one embodiment of the present application.

FIG. 5 is a flow chart illustrating an image mirroring method according to one embodiment of the present application.

FIG. 6 is a flow chart illustrating an image processing method according to one embodiment of the present application.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices. Further, in following embodiments, an Android system is used as an example for explaining, but does not mean to limit the scope of the present application. Also, in following embodiments, a first electronic device is used to perform the image mirroring method. Additionally, the WFD (WiFi Direct) is used as an example for explaining. However, communication paths which use different algorithms may also be applied to the present application.

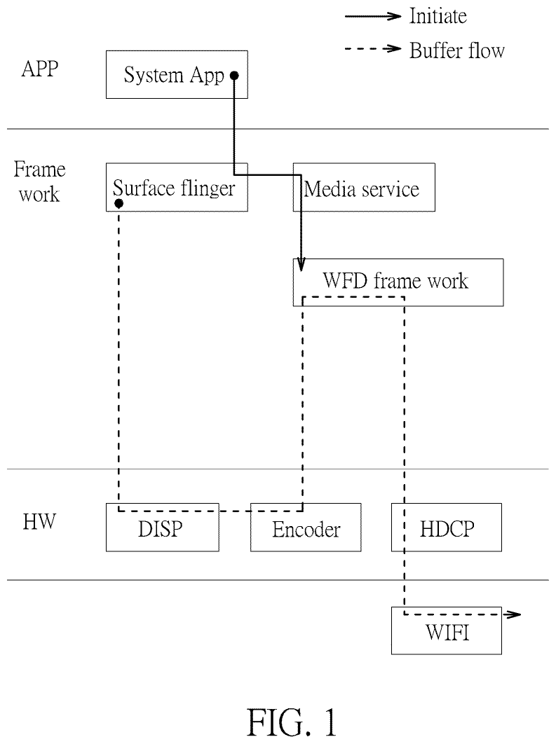

FIG. 1 is a schematic diagram illustrating an image mirroring method according to one embodiment of the present application. As shown in FIG. 1, the APP (application) installed in the first electronic device initiates the WFD framework, which can communicate with the WFD network. Further, the Surface Flinger, which can be regarded as a software image generation module, generates first target images according to the requirements provided by the APP. MediaService is a system service that handles various media-related operations, for example, audio and video decoding, encoding, and streaming. In one embodiment, the Surface Flinger and the MediaService are modules of a software level of the first electronic device.

Further, in FIG. 1, DISP is the display of the first electronic device. DISP receives the first target images from the Surface Flinger. The encoder, which is hardware, is used for encoding the first target images to generate a target video stream. The DISP and the encoder are devices of a hardware level of the first electronic device. The negotiation between the DISP and the encoder is based on a request. The request may be a software level request or a hardware level request including an IRQ (Interrupt Request). For more detail, after the DISP receives a first target image from the software image generation module, the DISP transmits the first target image to the encoder and immediately (i.e., in a short period of time after transmitting the first target image) transmits the request to the encoder. By this way, it can ensure that the timing of transmitting the first target image to the encoder and the timing of encoding the first target image can be matched.

In one embodiment, the DISP and the encoder are synchronized to make the negotiation between the DISP and the encoder more effective. The synchronization mentioned here may be implemented by various methods, such as: IRQ, polling, Message Q, Signals, callback function or shared memory.

Afterwards, the target video stream is transmitted to the WFD frame work for transmission of the WFD network. Then HDCP (High-Bandwidth Digital Content Protection) is used for encrypting the target video stream, to increase the security of the target video stream during transmission. Next, the encrypted target video stream is transmitted to the WFD network WIFI. During the procedure of image mirroring, a second electronic device can receive the encrypted target video stream via the WFD network WIFI, and then decrypts the encrypted target video stream to acquire the first target images. In one embodiment, HDCP may be removed from the first electronic device. In such case, the second electronic device receives the target video stream rather than the encrypted target video stream.

The above-mentioned first electronic device can be any device which can provide the first target images and display the target video stream, such as a mobile phone or a tablet computer. Besides, the second electronic device can display the first target images, such as a TV.

Based upon the embodiment illustrated in FIG. 1, the DISP and the encoder can directly negotiate with each other by software level or hardware level requests, without using the software modules in the soft level. By this way, the negotiation between the DISP and the encoder may be faster and more efficient, and the data path can be shorten.

More specifically, in some related arts, a virtual image may also be generated by the software image generation module. Image contents of the virtual image are identical with image contents of the first target image. Afterwards, at least one software module acquires the virtual image and transmits the virtual image to the encoder. However, such steps are time consuming and need more processing steps. In the embodiment of FIG. 1, no virtual image is generated and the encoder in FIG. 1 directly receives the first target image from the DISP rather than received by the software modules. By this way, less processing time is needed and less processing steps are required.

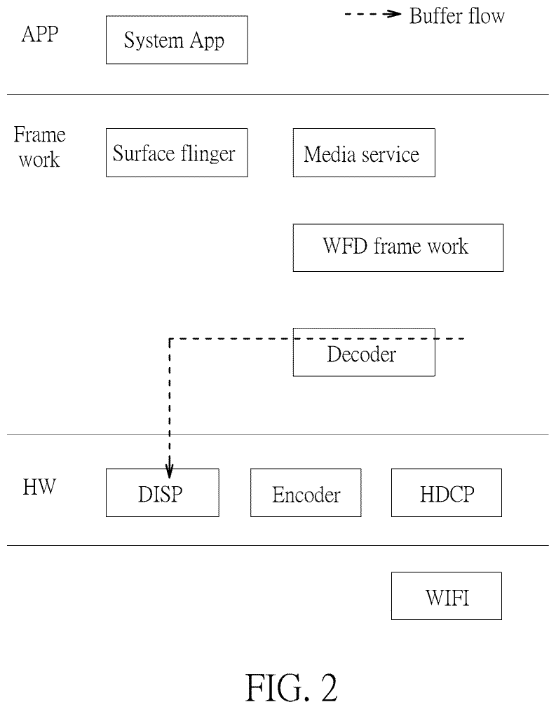

Besides the first target images generated according to the requirements provided by APP, the DISP of the first electronic device may also receive other target images from another image source. FIG. 2 is a schematic diagram illustrating an image mirroring method according to another embodiment of the present application. In the embodiment of FIG. 2, the decoder, which is hardware, receives a video stream and decodes the video stream to generate second target images. The second target images are transmitted to the DISP and then the DISP display the second target images. The embodiment shown in FIG. 2 may be applied to any scenario. For example, a mobile phone receives a movie from a website and displays the movie.

The negotiation between the DISP and the decoder is based on a hardware level request, such as an IRQ. In one embodiment, the DISP and the decoder are synchronized to make the negotiation between the DISP and the decoder more effective. The synchronization mentioned here may be implemented by various methods, such as: IRQ, polling, Message Q, Signals, callback function or shared memory. Please note, the synchronization mentioned here may mean synchronization using the above-mentioned request.

In the embodiment of FIG. 2, the above-mentioned image mirroring method can still be used. In such case, the DISP receives the second target images from the decoder and transmit the second target images to the encoder. The encoder encoding the second target images to generate a target video stream. The negotiation between the DISP and the encoder may be based on a software level request or a hardware level request including an IRQ. As above-mentioned, the DISP and the encoder may also be synchronized to make the negotiation between the DISP and the encoder more effective. Such synchronization may be performed via the above-mentioned request.

In the embodiment of FIG. 2, the DISP also receives the second target image based on the above-mentioned request. More specifically, in the embodiment of FIG. 2, the decoder transmits the request to inform the DISP to receive the second target image immediately after transmits second target image. By this way, the timing of the decoder transmitting the second target image and the timing of the DISP receiving the second target image can be matched.

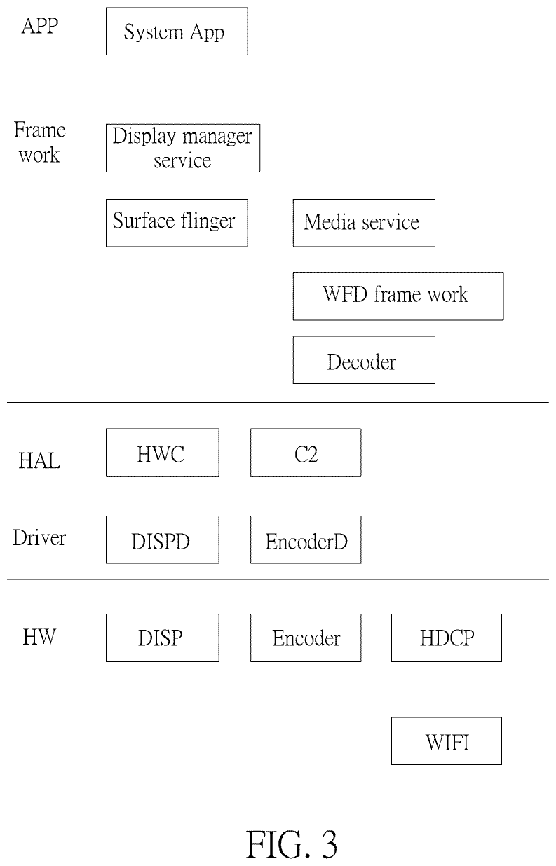

The above-mentioned first electronic device may further comprise other modules or software. FIG. 3 is a detail schematic diagram of the image mirroring method in FIG. 1, according to one embodiment of the present application. Please note, FIG. 3 is only an example for explain the present application but does not mean any limitation of the present application. In the embodiment of FIG. 3, besides the modules and the devices shown in FIG. 1 and FIG. 2, the first device further comprises the display manager service, which is a module used for managing the display of the first electronic device. Further, the decoder is illustrated in FIG. 3, but the decoder can be removed if the first electronic device is only for encoding the first target image as shown in the embodiment of FIG. 1.

Besides, in the embodiment of FIG. 3, the first electronic device further comprises HWC, which means hardware composer for composing different image layers. Also, the first electronic device further comprises C2 (codec 2) which means an API (application program interface) of the HAL (Hardware Abstraction Layer). Additionally, in the embodiment of FIG. 3, the first electronic device further comprises the display driver DISPD and the encoder driver EncoderD. In one embodiment, at least one of the modules illustrated in FIG. 1-FIG. 3 is provided by an OS (Operation System) installed in the first electronic device.

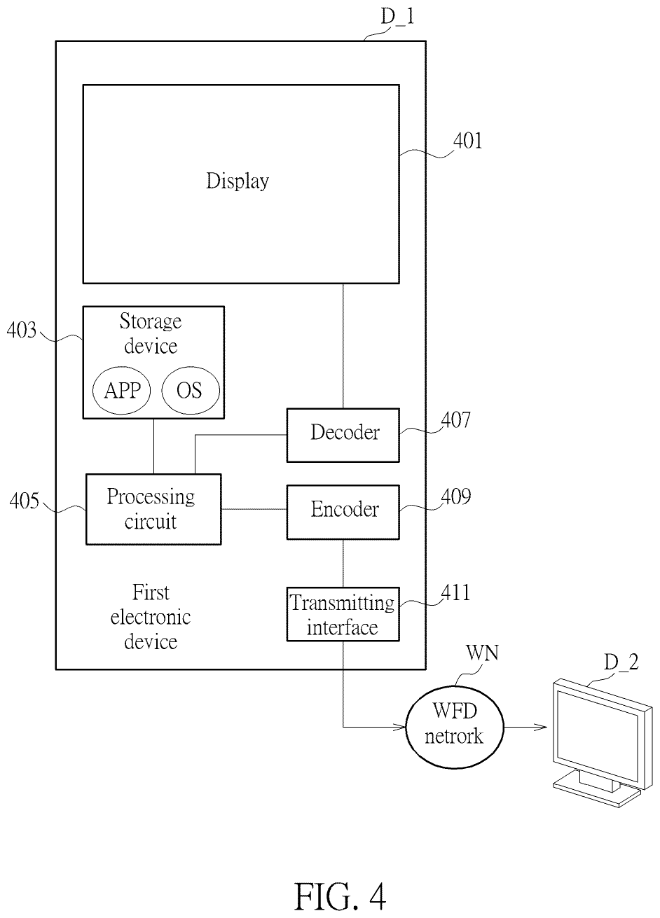

The above-mentioned first electronic device may comprise various structures. FIG. 4 is a block diagram illustrating a first electronic device which can perform the image mirroring method illustrated in the embodiments of the present application, according to one embodiment of the present application. As illustrated in FIG. 4, the first device D 1 comprises a display 401 (DISP in FIG. 1-FIG. 3), a storage device 403, a processing circuit 405, a decoder 407, an encoder 409 and a transmitting interface 411.

The display 401 is configured to display the first target images or second target images, as above-mentioned. The storage device 403 is configured to store programs, for example, the APP or an OS may be installed in the storage device 403. Please note, the APP and the operation system OS may be installed to different storage devices. The operation system OS may comprise the modules illustrated in FIG. 1-FIG. 3. Further, the storage device 403 may be provided outside the first electronic device D 1.

The processing circuit 405 is configured to control the operations of the first electronic device D 1. The processing circuit 405 may be any circuit or any device which has computation abilities or control abilities, such as a CPU (Central Processing Unit) or a MCU (Microcontroller Unit). The decoder 407 and the encoder 409 are respectively the above-mentioned decoder and encoder. The transmitting interface 411 is configured to transmit the above-mentioned target video stream or the encrypted target video stream to the WFD network WN (WIFI shown in FIG. 1-FIG. 3). The second electronic device D 2 may receive the target video stream via the WFD network WN.

In one embodiment, the transmitting interface 411 may be a transceiving interface. In such case, the decoder 407 may receive the above-mentioned video stream. However, the decoder 407 may receive the video stream via a receiving interface independent from the transmitting interface 411. The first electronic device D 1 may further comprises other devices or circuits besides the components shown in FIG. 4. For example, the first electronic device D 1 may comprise a graphic device such as a GPU (Graphics Processing Unit) which may generate images according to the requirements provided by the APP.

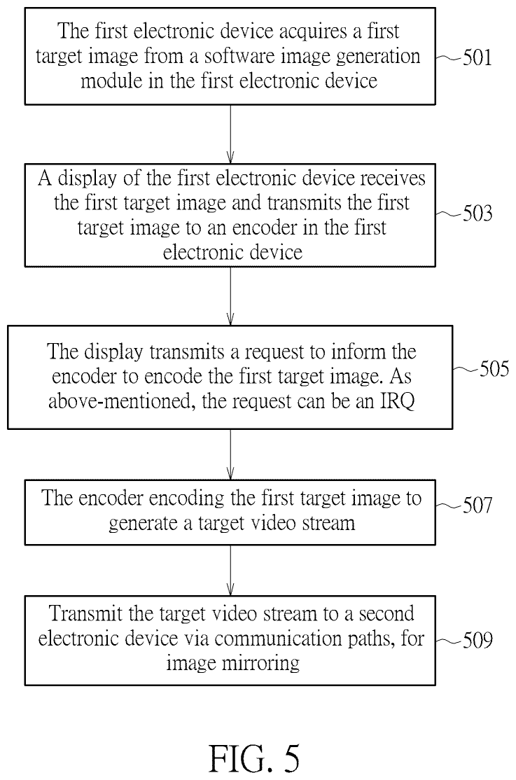

In view of above-mentioned embodiments, an image mirroring method can be acquired, which is applied to a first electronic device (e.g., D 1) and a second electronic device (e.g., D 2). FIG. 5 is a flow chart illustrating an image mirroring method according to one embodiment of the present application. The image mirroring method in FIG. 5 comprises:

### Step 501

The first electronic device acquires a first target image from a software image generation module in the first electronic device.

### Step 503

A display of the first electronic device receives the first target image and transmits the first target image to an encoder in the first electronic device.

### Step 505

The display transmits a request to inform the encoder to encode the first target image.

### Step 507

The encoder encodes the first target image to generate a target video stream

### Step 509

Transmit the target video stream to a second electronic device via communication paths, for image mirroring.

The image mirroring method may further comprise: the display receives second target images from a decoder in the first electronic device (e.g., the embodiment in FIG. 2); and displaying the second target images by the display.

As above-mentioned, the software image generation module may be the SurfaceFlinger. Also, the request may be a software level request or a hardware level request including an IRQ.

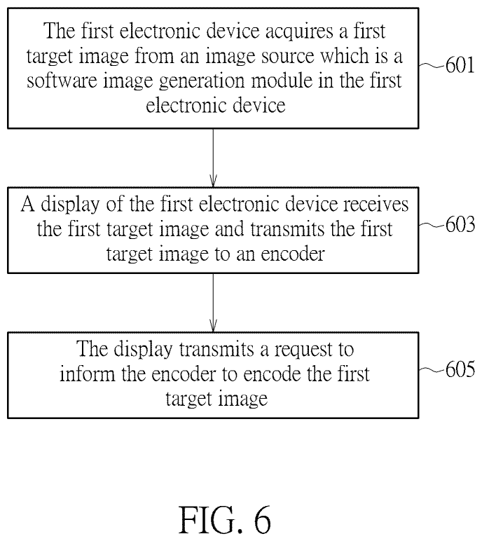

The above-mentioned image processing performed by the first electronic device is not limited to be applied to image mirroring. Accordingly, an image processing method can be acquired based on the above-mentioned embodiments, and the first electronic device can be regarded as an image processing device. FIG. 6 is a flow chart illustrating an image processing method according to one embodiment of the present application. The image processing method in FIG. 6 comprises:

### Step 601

The first electronic device acquires a first target image from an image source which is a software image generation module in the first electronic device.

### Step 603

A display of the first electronic device receives the first target image and transmits the first target image to an encoder

### Step 605

The display transmits a request to inform the encoder to encode the first target image.

As above-mentioned, the software image generation module may be the SurfaceFlinger. Besides, the request may be a software level request or a hardware level request including an IRQ.

Other details of the image mirroring method and the image processing method can be acquired based on the above-mentioned embodiments, thus descriptions thereof are omitted for brevity here.

In view of above-mentioned embodiments, the displaying latency of the image mirroring method and the processing latency of the image processing method can be reduced, since the data paths are shorten.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, applied to a first electronic device, comprising:
the first electronic device acquiring a first target image from an image source which is a software image generation module in the first electronic device;
a display of the first electronic device receiving the first target image and transmitting the first target image to an encoder; and
the display transmitting a request to inform the encoder to encode the first target image.

2. The image processing method of claim 1, wherein the encoder does not receive any virtual image from the image source via at least one software module, wherein image contents of the virtual image are identical with image contents of the first target image.

3. The image processing method of claim 1, further comprising:
encoding the first target image to generate a target video stream by the encoder; and
transmitting the target video stream to a second electronic device via communication paths.

4. The image processing method of claim 1, wherein the image generation module is a SurfaceFlinger.

5. The image processing method of claim 1, further comprising:
synchronizing the display and the encoder.

6. The image processing method of claim 1, further comprising:
the display receiving a second target image from a decoder in the first electronic device;
informing the display to receive the second target image by using the request.

7. The image processing method of claim 6, further comprising:
synchronizing the display and the decoder.

8. The image processing method of claim 1, wherein the request is a hardware level request including an IRQ (Interrupt Request).

9. An image mirroring method, applied to a first electronic device and a second electronic device, comprising:
the first electronic device acquiring a first target image from a software image generation module in the first electronic device;
a display of the first electronic device receiving the first target image and transmitting the first target image to an encoder in the first electronic device;
the display transmitting a request to inform the encoder to encode the first target image;
the encoder encoding the first target image to generate a target video stream; and
transmitting the target video stream to a second electronic device via communication paths, for image mirroring.

10. The image mirroring method of claim 9, wherein the encoder does not receive any virtual image from the image source via at least one software module, wherein image contents of the virtual image are identical with image contents of the first target.

11. The image mirroring method of claim 9, wherein the image generation module is a SurfaceFlinger.

12. The image mirroring method of claim 9, further comprising:
synchronizing the display and the encoder.

13. The image mirroring method of claim 9, further comprising:
the display receives second target images from a decoder in the first electronic device; and
informing the display to receive the second target image by using the request.

14. The image mirroring method of claim 13, further comprising:
synchronizing the display and the decoder.

15. The image mirroring method of claim 9, wherein the request is a hardware level request including an IRQ (Interrupt Request).

16. An image processing device, comprising:
a display;
an image source;
an encoder; and
a processing circuit, configured to execute at least one program to perform an image processing method, the image processing method comprising:
the image processing device acquiring a first target image from the image source which is a software image generation module in the image processing device;
a display of the image processing device receiving the first target image and transmitting the first target image to an encoder; and
the display transmitting a request to inform the encoder to encode the first target image.

17. The image processing device of claim 16, wherein the encoder does not receive any virtual image from the image source via at least one software module, wherein image contents of the virtual image are identical with image contents of the first target image.

18. The image processing device of claim 16, wherein the encoder encodes the first target image to generate a target video stream, wherein the image processing device
transmits the target video stream to an electronic device via communication paths.

19. The image processing device of claim 16, wherein the image generation module is a SurfaceFlinger.

20. The image processing device of claim 16, further comprises a decoder, wherein the display receives a second target image from the decoder, wherein the decoder informs the display to receive the second target image by using the request.

21. The image processing method of claim 16, wherein the request is a hardware level request including an IRQ (Interrupt Request).
